(19) United States
(12) Patent Application Publication
(10) Pub. No.: US 2022/0349724 A1
(43) Pub. Date: Nov. 3, 2022

(54) METHOD FOR OPERATING A NAVIGATION APPARATUS, AND NAVIGATION APPARATUS

(71) Applicant: Volkswagen Aktiengesellschaft, Wolfsburg (DE)

(72) Inventors: Mi-Ran Jun, Berlin (DE); Jian Lou, Berlin (DE); Tobias Budzynski, Berlin (DE); Omer Yosha, Berlin (DE)

(21) Appl. No.: 17/441,609

(22) PCT Filed: Mar. 11, 2020
(86) PCT No.: PCT/EP2020/056408

§ 371 Date: Sep. 21, 2021

(30) Foreign Application Priority Data
Mar. 25, 2019 (DE) 10 2019 2040 36.5

(51) Int. Cl. G01C 21/36

(52) U.S. Cl. CPC G01C 21/3626; G01C 21/3667

(57) ABSTRACT

Technologies and techniques for operating a navigation apparatus, wherein the navigation apparatus includes a display device and a control device for controlling the display device. A navigation suggestion for an upcoming traffic maneuver is output on the display device, and wherein at least one further navigation suggestion for at least one traffic maneuver following the upcoming traffic maneuver is output on the display device. The present disclosure also relates to a navigation apparatus.

### CROSS REFERENCE TO RELATED APPLICATION

The present application claims priority to International Patent App. No. PCT/EP2020/056408 to Jun, et al., titled “Method for Operating a Navigation Apparatus, And Navigation Apparatus”, filed Mar. 11, 2020, which claims priority to German Patent App. No 10 2019 204 036.5, filed Mar. 25, 2019, the contents of each being incorporated by reference in their entirety herein.

### FIELD OF TECHNOLOGY

The present disclosure relates to a method for operating a navigation apparatus, and a navigation apparatus.

### BACKGROUND

Navigation apparatuses are known, with which it is possible to navigate along a specified route on the basis of a map stored in a memory or online and current position information determined, for example, by means of a global positioning system. Navigation instructions for an upcoming traffic maneuver are output on a display for this.

The means of providing instructions in navigation apparatuses is currently unsatisfactory.

### SUMMARY

Aspects of the present disclosure are to improve a method for operating a navigation apparatus, and improve the navigation apparatus.

Certain aspects directed to methods and navigation systems are described in the independent claims. Other aspects of the present disclosure can be derived from the dependent claims.

In some examples, a method for operating a navigation apparatus is disclosed, wherein the navigation apparatus comprises a display unit and a control unit for controlling the display unit, wherein navigation instructions for an upcoming traffic maneuver are output on the display unit, and wherein at least one further navigation instruction is output on the display unit for at least one traffic maneuver following the upcoming traffic maneuver.

In some examples, a navigation apparatus is also disclosed, comprising a display unit and a control unit for controlling the display unit, wherein the control unit is configured to output navigation instructions on the display unit for an upcoming traffic maneuver, and wherein the control unit is also configured to output at least one additional navigation instruction on the display unit for at least one traffic maneuver following the upcoming traffic maneuver.

The method and the navigation apparatus give the user a better overview of upcoming traffic maneuvers. This is obtained in that not only are navigation instructions displayed for the upcoming traffic maneuver on a specific route, but also at least one further navigation instruction is displayed for at least one further traffic maneuver following the upcoming traffic maneuver. This gives the user a better overview of a current situation, such that the user can better assess this situation and prepare for future traffic maneuvers. Navigation with a navigation apparatus can thus be made more intuitive and clearer.

The method and the navigation apparatus can be used for example in a motor vehicle. For example, the method and the navigation apparatus can also be used in other application scenarios, e.g., a smartphone and/or bicycle computer.

The control unit receives position information, e.g., from a global positioning system (e.g., Global Positioning System, Galileo, etc.) or some other service provider, and reconciles this position information with a map. The map can be stored in a memory in the control unit and/or online, and retrieved via the internet. Based on a current position in the map derived from the position information, and a desired route, and/or desired destination within the map, the control unit determines navigation instructions for an upcoming traffic maneuver. These navigation instructions are displayed on the display unit. The control unit activates the display unit for this accordingly, e.g. through digital control data. The control unit also determines at least one further navigation instruction for a traffic maneuver following the upcoming traffic maneuver on the basis of the derived current position and the desired route. This at least one further navigation instruction is also displayed on the display unit.

The display unit can also form a display/operating device, for example in the form of a touchscreen. In addition to the display, (virtual) operating elements can also be actuated, and this actuation can then be processed by the control unit.

The control unit can comprise both hardware and software, e.g., in the form of program code that is executed on a microcontroller or microprocessor.

Navigation instructions can include text instructions (directions) and/or graphics (arrows, traffic signs, direction signs, lane information, etc.). Navigation instructions can also comprise animation, e.g., an animated arrow.

In one embodiment, the display of the at least one further instruction is smaller than that of the first navigation instruction. This gives the user a better idea of the temporal, spatial and/or logical sequence of the navigation instructions.

In one embodiment, the at least one further navigation instruction is shown in a perspective view behind the first navigation instructions. This helps the user by providing a clearer idea of the temporal, spatial, and/or logical sequence of the navigation instructions. For example, if there are more than two navigation instructions, the sequence, or order, is clearer.

In another embodiment, the at least one further navigation instruction is dimmed and/or displayed with lower contrast than the first navigation instructions. This helps the user by providing a clearer idea of the temporal, spatial, and/or logical sequence of the navigation instructions. For example, if there are more than two navigation instructions, the sequence, or order, is clearer.

In one embodiment, the at least one further navigation instruction is at least partially transparent in relation to other content on the display unit. This enables a prioritization of the navigation instructions displayed on the display unit. If the navigation instruction is not transparent, and the at least one further navigation instruction is transparent, the user is able to immediately determine the importance or priority of the one navigation instruction over the at least one further navigation instruction.

In one embodiment, the first navigation instructions partially overlap the at least one further navigation instruction. This helps the user in determining a temporal, spatial, and/or logical sequence or order for the navigation instructions. Thus, if there are more than two navigation instructions, the sequence, or order, is clearer.

In one embodiment, after completion of a traffic maneuver corresponding to the navigation instructions, the first navigation instructions are replaced by the at least one further navigation instruction in an animated manner. This gives the user a better indication that the first traffic maneuver has been successfully executed, and that the further traffic maneuver is now pending.

In another embodiment, the navigation instructions are located at the upper edge of the display unit. Because a map, in particular a perspective map, normally moves in the direction of movement, for example, the direction of travel, and additional content due to movement enters the display unit from the upper edge, the user's attention is normally focused on the upper edge of the display unit. Displaying the navigation information at the top therefore has the advantage that, because the user's attention is already focused on this area, the user is better able to see the navigation instruction.

In one embodiment, the navigation instructions are located horizontally in the middle of the display unit, or in the middle of the content shown on the display unit. Because the user's attention is normally focused on the middle, this makes it easier for the user to see the navigation instructions.

Features of the design of the navigation apparatus can be derived from the description of embodiments of the method. The advantages of the navigation apparatus are the same as those of the embodiments of the method.

### BRIEF DESCRIPTION OF THE DRAWINGS

Aspects of the present disclosure shall be explained in greater detail below on the basis of preferred exemplary embodiments, in reference to the drawings. Therein:

FIG. 1 shows a schematic illustration of an embodiment of the navigation apparatus according to some aspects of the present disclosure;

FIG. 2 shows a schematic illustration of the content displayed on a display unit, for clarification according to some aspects of the present disclosure.

### DETAILED DESCRIPTION

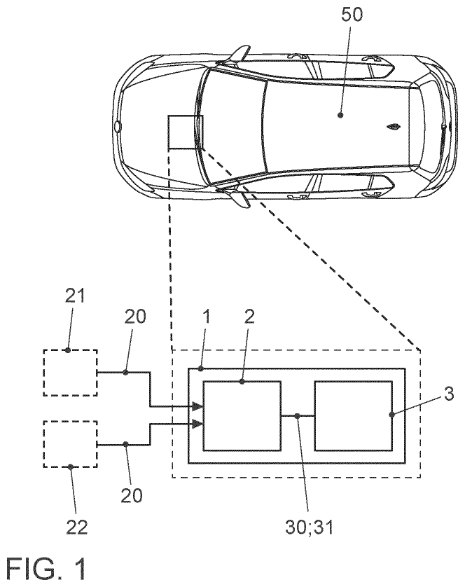

A schematic illustration of an embodiment of the navigation apparatus is shown in FIG. 1.

The navigation apparatus 1 may include a display unit 3, e.g. in the form of a touchscreen that allows user inputs to also be detected at the same time that the content is displayed, and a control unit 2 for controlling the display unit 3.

The control unit 2 can include a combination of hardware and software, e.g., in the form of program code that is executed on a microcontroller or microprocessor.

The control unit 2 actuates the display unit, where content shown on the display unit 3 is generated by the control unit 2 and displayed. If the display unit 3 forms a display and operating unit, e.g., in the form of a touchscreen, the control unit 2 can also process an actuation on such a display/operating unit. The navigation apparatus 1 can be configured via actuations on such a display and operating unit. By way of example, a desired destination and/or desired route can be input and/or selected by a user in this manner.

The control unit 2 may be configured to output navigation instructions 30 for an upcoming traffic maneuver on the display unit 3, and the control unit 2 is also configured to output at least one further navigation instruction 31 on the display unit 3 for at least one traffic maneuver following the upcoming traffic maneuver.

The control unit 2 may receive position information 20 for this, e.g., from a global positioning system 21 (e.g., Global Positioning System, Galileo, etc.), or some other service provider 22, and reconciles this position information 20 with a map 4. The map 4 is stored, e.g., in a memory 5 in the control unit 2, and/or is retrieved from and/or provided by the internet. The control unit 2 determines navigation instructions 30 for an upcoming traffic maneuver on the basis of a current position in the map 4 derived from the position information 20, and a desired route within the map 4. These navigation instructions 30 are displayed on the display unit 3. The control unit 20 actuates the display unit 3 accordingly, e.g., by providing digital control data. The control unit 2 also determines at least one further navigation instruction 31 for a traffic maneuver following the upcoming traffic maneuver based on the derived current position and desired route. The at least one further navigation instruction 31 that has been determined is likewise displayed on the display unit 3 by actuating the display unit 3.

The at least one further navigation instruction 31 can be displayed such that it is smaller than the first navigation instructions 30. The control unit 2 scales the at least one further navigation instruction 31 for this and provides corresponding control data to the display unit 3.

The at least one further navigation instruction 31 can also be displayed in a perspective view behind the first navigation instructions 30. The control unit 2 calculates a perspective display of the navigation instructions 30 and the at least one further navigation instruction 31 for this and provides corresponding control data to the display unit 3.

The at least one further navigation instruction 31 can also be dimmed and/or displayed with a lower contrast. The control unit 2 calculates corresponding brightness and/or contrast values for the navigation instructions 30 and the at least one further navigation instruction 31 for this, and provides corresponding control data to the display unit 3.

The at least one further navigation instruction 31 can also be at least partially transparent in relation to other content displayed on the display unit 3. The control unit 2 calculates corresponding pixel values for this by means of a weighted combination of image data for the at least one further navigation instruction 31 and the other content on the display unit 3 that is overlapped by the at least one further navigation instruction 31. The cumulative values are sent to the display unit 3 via corresponding control data. By way of example, the further navigation instruction 31 can be up to 85% transparent. If numerous navigation instructions 31 are displayed, the transparency increases with each further navigation instruction that is displayed.

The navigation instructions 30 can also partially overlap the at least one further navigation instruction 31. The control unit 2 calculates a collective overlapping display of the navigation instructions 30 and the at least one further navigation instruction 31, and provides corresponding control data to the display unit 3.

After completion of a traffic maneuver corresponding to the navigation instructions 30, the first navigation instructions 30 can be replaced in an animated manner by the at least one further navigation instruction 31. The control unit 2 calculates an animation from numerous individual images for this, and provides a calculation result to the display unit 3 in the form of corresponding control data.

The navigation instructions 30, 31 can be arranged horizontally in the middle of the display unit 3 or in the middle of the content displayed on the display unit 3. A corresponding arrangement is calculated by the control unit 2, taking the rest of the content into account, and provided to the display unit 3 in the form of corresponding control data.

Although an exemplary embodiment of a motor vehicle 50 is shown, the navigation apparatus 1 can also be used in principle in other application scenarios, e.g., a smartphone for pedestrian, bicycle, or automobile navigation. In principle, it can also be used in other vehicles, e.g., land, air, or water vehicles.

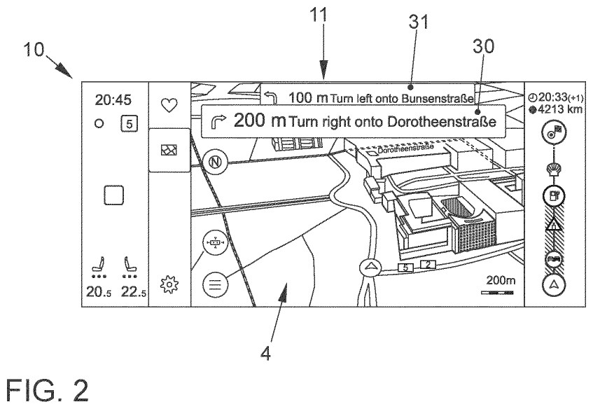

A schematic illustration of the content 10 displayed on the display unit is shown in FIG. 2 by way of clarifying the present disclosure. The content 10 displayed thereon comprises a navigational view of a map 4 shown in perspective in the middle of the display. Navigation instructions 30 for an upcoming traffic maneuver and further navigation instructions 31 for a traffic maneuver following the upcoming traffic maneuver are shown at the upper edge 11 of the content 10. The navigation instructions 30, 31 are arranged horizontally in the middle of the map 4.

The navigation instructions 30, 31 are formed by both text and graphics in this exemplary embodiment, wherein the text and the graphics are in white. The text and graphics are both placed in rectangular, dark boxes.

The further navigation instructions 31 are shown in a perspective view behind the navigation instructions 30.

The navigation instructions 30 overlap the further navigation instructions 31 at an upper edge of the first navigation instructions 30 and a lower edge of the further navigation instructions 31.

The further navigation instructions 31 can also be dimmed in comparison with the first navigation instructions 30.

The further navigation instructions 31 can also be partially transparent in relation to other content displayed on the display unit.

After completion of a traffic maneuver corresponding to the navigation instructions 30, the first navigation instructions 30 are replaced by the further navigation instructions 31 in an animated manner. In this case, the first navigation instructions 30 are slowly faded out, and the further navigation instructions 31 are slid in an animated manner into the position previously occupied by the first navigation instructions 30, and enlarged accordingly. At the same time, further navigation instructions for the next traffic maneuver appear in place of the previous further navigation instructions 31.

### LIST OF REFERENCE SYMBOLS

1 navigation apparatus
2 control unit
3 display unit
4 map
5 memory
10 displayed content
11 edge
20 position information
21 positioning system
22 other service providers
30 navigation instructions
31 further navigation instructions
50 motor vehicle

1-10. (canceled)

11. A navigation apparatus, comprising:
a display unit; and
a control unit for controlling the display unit, wherein a first navigation instruction for an upcoming traffic maneuver is output on the display unit, and wherein at least one further navigation instruction is output concurrently on the display unit for at least one traffic maneuver following the upcoming traffic maneuver.

12. The navigation apparatus according to claim 11, wherein the control unit and display unit are configured to display of the at least one further navigation instruction is smaller than that of the first navigation instruction.

13. The navigation apparatus according to claim 11, wherein the control unit and display unit are configured to display the at least one further navigation instruction in a perspective behind the first navigation instruction.

14. The navigation apparatus according to claim 11, the control unit and display unit are configured to dim and/or display the further navigation instruction with a lower contrast in relation to the first navigation instruction.

15. The navigation apparatus according to claim 11, wherein the at least one further navigation instruction is configured to be at least partially transparent in relation to other content displayed on the display unit.

16. The navigation apparatus according to claim 11, wherein the first navigation instruction is configured to partially overlap the at least one further navigation instruction.

17. The navigation apparatus according to claim 11, wherein, after completing a traffic maneuver corresponding to the first navigation instructions, the control unit and display unit are configured to replace the first navigation instruction by the at least one further navigation instruction in an animated manner.

18. The navigation apparatus according to claim 11, wherein the control unit and display unit are configured to place the navigation instructions at an upper edge of the display unit.

19. The navigation apparatus according to claim 11, wherein the control unit and display unit are configured to arrange the navigation instructions horizontally in the middle of the display unit or in the middle of content displayed on the display unit.

20. A method of operating navigation apparatus, comprising:
displaying a first navigation instruction for a traffic maneuver on a display unit via a control unit;
receiving a further navigation instruction for an upcoming traffic maneuver on the basis of a current position;
determining a display configuration for the display unit; and
displaying the further navigation instruction on the display unit for the at least one traffic maneuver following the upcoming traffic maneuver based on the display configuration, wherein the further navigation instruction and first navigation instruction are displayed concurrently.

21. The method according to claim 20, wherein the at least one further navigation instruction is displayed smaller than the first navigation instruction.

22. The method according to claim 20, wherein the at least one further navigation instruction is displayed in a perspective behind the first navigation instruction.

23. The method according to claim 20, wherein the further navigation instruction is dimmed and/or displayed with a lower contrast in relation to the first navigation instruction.

24. The method according to claim 20, wherein the at least one further navigation instruction is displayed to be at least partially transparent in relation to other content displayed on the display unit.

16. The method according to claim 20, wherein the first navigation instruction is displayed to partially overlap the at least one further navigation instruction.

25. The method according to claim 20, further comprising, after completing a traffic maneuver corresponding to the first navigation instructions, replacing the first navigation instruction by the at least one further navigation instruction in an animated manner.

26. The method according to claim 20, further comprising placing the navigation instruction at an upper edge of the display unit.

27. The method according to claim 20, further comprising arranging the navigation instructions horizontally in the middle of the display unit or in the middle of content displayed on the display unit.

28. A navigation apparatus, comprising:
a display unit; and
a control unit for controlling the display unit, wherein the control unit and display unit are configured to
display a first navigation instruction for a traffic maneuver on a display unit,
receive a further navigation instruction for an upcoming traffic maneuver on the basis of a current position;
determine a display configuration for the display unit; and
display the further navigation instruction on the display unit for the at least one traffic maneuver following the upcoming traffic maneuver based on the display configuration, wherein the further navigation instruction and first navigation instruction are displayed concurrently, and wherein the concurrent display comprises one of:
displaying the further navigation instruction to be smaller than that of the first navigation instruction,
displaying the further navigation instruction in a perspective behind the first navigation instruction,
dimming and/or displaying the further navigation instruction with a lower contrast in relation to the first navigation instruction,
configuring the further navigation instruction to be at least partially transparent in relation to other content displayed on the display unit, and
configuring the first navigation instruction to partially overlap the further navigation instruction.

29. The navigation system according to claim 28, wherein the control unit and display unit are configured to, after completing a traffic maneuver corresponding to the first navigation instructions, replace the first navigation instruction by the at least one further navigation instruction in an animated manner.

30. The navigation system according to claim 28, wherein the control unit and display unit are configured to (i) place the navigation instruction at an upper edge of the display unit, or (ii) arrange the navigation instructions horizontally in the middle of the display unit or in a middle of content displayed on the display unit.
